(19) United States
(12) Patent Application Publication
(10) Pub. No.: US 2018/0231772 A1
(43) Pub. Date: Aug. 16, 2018

(54) HEAD UP DISPLAY APPARATUS FOR REALIZING MULTI-DISPLAY FIELD CAPABLE OF INDIVIDUAL CONTROL AND DISPLAY CONTROL METHOD THEREOF

(71) Applicant: Hyundai Mobis Co., Ltd., Seoul (KR)

(72) Inventors: Sang Hoon HAN, Seoul (KR); Chan Young YOON, Gwangmyeong-si (KR); Jung Hoon SEO, Seoul (KR)

(21) Appl. No.: 15/870,991

(22) Filed: Jan. 14, 2018

(30) Foreign Application Priority Data
Feb. 14, 2017 (KR) 10-2017-0019871

(51) Int. Cl. G02B 27/01

(52) U.S. Cl. CPC G02B 27/0101; B60K 2350/2052; G02B 2027/0183; G02B 2027/0181

(57) ABSTRACT

Provided is a head up display (HUD) apparatus for realizing multi-display field and a display control method thereof. The HUD apparatus includes a first image processing unit allowing a virtual image, corresponding to driving information or vehicle information generated from a first image source, to be displayed on a main display field and a second image processing unit allowing a virtual image, corresponding to at least one of driving information, image information, and vehicle information generated from a second image source, to be displayed on a sub display field.

### CROSS-REFERENCE TO RELATED APPLICATIONS

This application claims priority from and the benefit of Korean Patent Application No. 10-2017-0019871, filed on Feb. 14, 2017, which is hereby incorporated by reference for all purposes as if set forth herein.

### BACKGROUND

### Field

Exemplary embodiments relates to a head up display (HUD) apparatus for realizing multi-display field capable of individual control and a display control method thereof, and more particularly, to an HUD apparatus for realizing multi-display field capable of individual control and a display control method thereof, which provide various pieces of vehicle information to a driver through the HUD apparatus because a focal point of the driver is changed based on a velocity of a vehicle, generate a plurality of display fields to divide a display field of a screen according to content which is to be displayed, and display information about the content by field positions to enable the driver to recognize vehicle information through a minimum movement of an eye-gaze while the driver is driving the vehicle, thereby enhancing convenience and driving safety.

### Discussion of the Background

Generally, HUD apparatuses are apparatuses which display information about a vehicle and driving information to a driver through a wind shield disposed in a front portion to minimize a movement of an eye-gaze of driver while the vehicle is driving, thereby providing information so as not to disperse front caution.

The HUD apparatuses each include an image source such as a liquid crystal display (LCD) or a projector, an optical system which allows an image generated and projected from the image source to be formed at an appropriate distance and an effective focal distance, and an interface for control of a driver.

A display method performed by a picture generation unit (PGU) configuring a related art HUD apparatus will be described with reference to FIGS. 1A to 1C. FIG. 1A is a diagram showing an example where driving information displayed by the PGU configuring the related art HUD apparatus is displayed on a lower end, FIG. 1B is a diagram showing an example where the driving information is moved to and displayed on an upper end in the drawing of FIG. 1A, and FIG. 1C is a diagram showing an example where long-distance content is displayed along with the driving information in the drawing of FIG. 1A.

In general HUD apparatuses, driving information is displayed on an eye box to overlap the eye box in a forward view depending on an eye height of a driver. When a height at which driving information is displayed is changed within a field of view of a driver, fixed driving information is displayed separately from perspective in an actual field of view.

The related art HUD apparatus uses a single PGU and displays an image at a fixed magnification at a fixed projection distance, and vehicle information content such as a vehicle warning light is displayed by a separate display device such as a cluster.

Moreover, in a case of configuring a system by using a plurality of PGUs, in order to ensure a field of view (FOV) of a driver, a size of an aspheric mirror increases, and a package size increases.

In the related art HUD apparatus, in a case of displaying various pieces of driving information (geographic information, a direction, a velocity, etc.) necessary for driving in an FOV of a driver in a direction which a vehicle drives, since the related art HUD apparatus is configured with the single PGU, a display field is limited due to a limitation of a viewing angle of the driver when displaying pieces of driving information at a single projection distance (a focal point) and a magnification.

Moreover, in the related art, in order to display various pieces of content, an image size of significant information should be reduced or a position should be changed, a height of displayed driving information should be controlled based on an FOV and preference of a driver. Also, a focal distance of the driver is changed based on a velocity and the various pieces of content are displayed at a fixed focal distance, and for this reason, since the focal distance of the driver differs from a focal distance of an HUD image, driving of a vehicle is obstructed.

The above information disclosed in this Background section is only for enhancement of understanding of the background of the invention and, therefore, it may contain information that does not constitute prior art.

### SUMMARY

Exemplary embodiments of the present invention provide an HUD apparatus for realizing multi-display field capable of individual control and a display control method thereof, which generate a plurality of display fields to divide a display field of a screen according to content which is to be displayed, and display information about the content by field positions to enable a driver to recognize vehicle information through a minimum movement of an eye-gaze while the driver is driving the vehicle, thereby enhancing recognizability.

Exemplary embodiments of the present invention also provide an HUD apparatus for realizing multi-display field capable of individual control and a display control method thereof, which accurately provide a focal point of a driver to the driver according to a velocity of a vehicle in a case of providing various pieces of vehicle information to the driver, thereby increasing driving safety.

Additional features of the invention will be set forth in the description which follows, and in part will be apparent from the description, or may be learned by practice of the invention.

An exemplary embodiment of the present invention discloses a head up display (HUD) apparatus for realizing multi-display field including: a first image processing unit allowing a virtual image, corresponding to driving information or vehicle information generated from a first image source, to be displayed on a main display field; and a second image processing unit allowing a virtual image, corresponding to at least one of driving information, image information, and vehicle information generated from a second image source, to be displayed on a sub display field.

The first image processing unit may allow a first virtual image to be displayed at a distance relatively far away from a driver, the second image processing unit may allow a second virtual image to be displayed at a distance relatively close to the driver, and the first virtual image and the second virtual image may be vertically or laterally aligned and displayed.

The first image processing unit may include: a picture generation unit providing an image source; an optical system reflecting an image generated by the picture generation unit to allow the first virtual image to be displayed on a display field disposed at a certain distance; a module body including one surface opened to transmit the first virtual image, the optical system being accommodating into the module body; and a transparent cover covering the opened one surface of the module body, and the second image processing unit may include: an image source output unit outputting the image source; and a self-emitting panel provided with an image output from the image source output unit to display a corresponding image as a second virtual image on a display field disposed at a certain distance by self-emitting light.

The first virtual image may be an image corresponding to content including vehicle driving information, and the second virtual image may be an image corresponding to content including image information provided from a camera equipped in the vehicle and cluster display information.

At least one of the first virtual image and the second virtual image may be configured for image correction to be performed.

The first virtual image may be corrected by controlling an aspheric mirror configuring the optical system of the first image processing unit, and the second virtual image may be a fixed image.

Another exemplary embodiment of the present invention discloses a head up display (HUD) apparatus for realizing multi-display field including: a display information setting unit selecting content which is to be displayed, and selecting single display or multi-display; and a multi-display image processing unit displaying the content set by the display information setting unit on two or more individual display fields.

The multi-display image processing unit may include: an image input synthesis unit selecting and synthesizing display information when the display information setting unit sets multi-display; and a multi-field output unit displaying display information, obtained through processing by the image input synthesis unit, on two or more fields.

The image input synthesis unit may be provided with content including cluster display information and image information obtained from a camera installed in a vehicle and selects and synthesizes the content.

The multi-image output unit may include: a long-distance virtual processing unit including a picture generation unit; and a close-distance virtual processing unit including a panel provided with an image source to display an image by self-emitting light.

The long-distance virtual processing unit may include: an image generation unit providing the image source; an optical system reflecting an image generated by the image generation unit to allow a virtual image to be displayed on a display field disposed at a certain distance; a module body including one surface opened to transmit the virtual image, the optical system being accommodating into the module body; and a transparent cover covering the opened one surface of the module body.

The close-distance virtual processing unit may include: an image source output unit outputting the image source; and a self-emitting panel provided with an image output from the image source output unit to display a corresponding image as a virtual image on a display field disposed at a certain distance by self-emitting light.

The long-distance virtual processing unit may include: an image generation unit providing the image source; an optical system reflecting an image generated by the image generation unit to allow a virtual image to be displayed on a display field disposed at a certain distance; a module body including one surface opened to transmit the virtual image, the optical system being accommodating into the module body; and a transparent cover covering the opened one surface of the module body, and the close-distance virtual processing unit may include: an image source output unit outputting the image source; and a self-emitting panel provided with an image output from the image source output unit to display a corresponding image as a virtual image on a display field disposed at a certain distance by self-emitting light.

The self-emitting panel of the close-distance virtual processing unit may include an organic light emitting diode (OLED) panel deposited on one side of the transparent cover of the long-distance virtual processing unit.

The HUD apparatus may further include: a display field control unit controlling information about each of a long-distance virtual display field and a close-distance virtual display field which are fields displayed by the multi-image output unit; and an image processing unit correcting distortion of content which is controlled by the display field control unit and is to be displayed on a display field, and moving a display position.

Another exemplary embodiment of the present invention discloses a display control method of a head up display (HUD) apparatus for realizing multi-display field including: allowing cluster information or driving information generated from a main image source to be displayed on a virtual main display field; and allowing at least one of driving information, image information, and cluster information generated from a second image source and one or more sub image sources to be displayed on a virtual sub display field.

The display control method may further include adjusting luminance, brightness, and a position of each of a virtual image displayed on the virtual main display field and a virtual image displayed on the virtual sub display field.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A is a diagram showing an example where driving information displayed by a PGU configuring a related art HUD apparatus is displayed on a lower end.

FIG. 1B is a diagram showing an example where the driving information is moved to and displayed on an upper end in the drawing of FIG. 1A.

FIG. 1C is a diagram showing an example where long-distance content is displayed along with the driving information in the drawing of FIG. 1A.

FIG. 2 is a block diagram of an HUD apparatus for realizing multi-display field capable of individual control according to an embodiment of the present invention.

FIG. 3 is a diagram schematically illustrating a configuration of a multi-image output unit configuring an HUD apparatus for realizing multi-display field capable of individual control according to an embodiment of the present invention.

FIG. 4 is a diagram illustrating an example of a hardware configuration of a multi-image output unit configuring an HUD apparatus for realizing multi-display field capable of individual control according to an embodiment of the present invention.

FIG. 5 is an exploded diagram of an example of a hardware configuration of a multi-image output unit configuring an HUD apparatus for realizing multi-display field capable of individual control according to an embodiment of the present invention.

FIG. 6 is a diagram showing display information generated by an HUD apparatus for realizing multi-display field capable of individual control according to an embodiment of the present invention.

FIGS. 7 to 10 are diagrams showing an example of various pieces of content displayed by a multi-image output unit in an HUD apparatus for realizing multi-display field capable of individual control according to an embodiment of the present invention.

FIG. 11 is a diagram illustrating an example where multi display fields are aligned and displayed in an HUD apparatus for realizing multi-display field capable of individual control according to an embodiment of the present invention.

FIG. 12 is a diagram illustrating an example of controlling an aspheric mirror when multi display fields are displayed to overlap one another, in an HUD apparatus for realizing multi-display field capable of individual control according to an embodiment of the present invention.

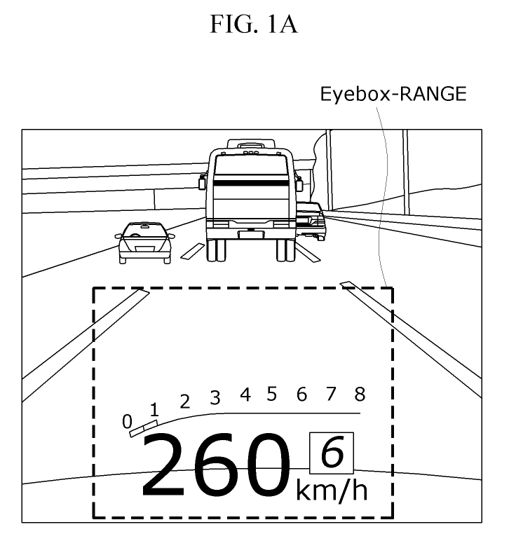

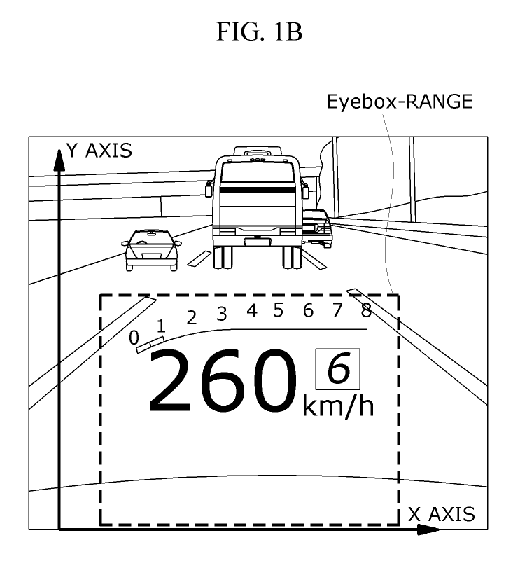

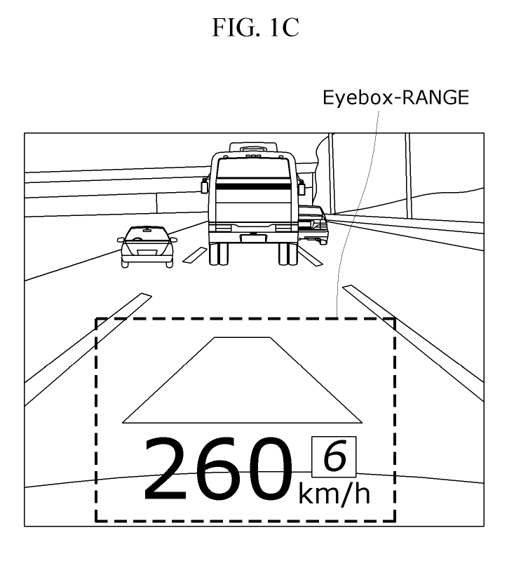

### DETAILED DESCRIPTION OF ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

The present invention may have diversely modified embodiments, and thus, example embodiments are illustrated in the drawings and are described in the detailed description of the present invention. However, this does not limit the invention within specific embodiments and it should be understood that the present invention covers all the modifications, equivalents, and replacements within the idea and technical scope of the invention.

In the case in which a component is referred to as being “connected” or “accessed” to other component, it should be understood that not only the component is directly connected or accessed to the other component, but also there may exist another component between the components. Meanwhile, in the case in which a component is referred to as being “directly connected” or “directly accessed” to other component, it should be understood that there is no component therebetween.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

Moreover, each of terms such as “ . . . part”, “ . . . unit”, and “module” described in specification denotes an element for performing at least one function or operation, and may be implemented in hardware, software or the combination of hardware and software.

In adding reference numerals for elements in each figure, it should be noted that like reference numerals already used to denote like elements in other figures are used for elements wherever possible. Moreover, detailed descriptions related to well-known functions or configurations will be ruled out in order not to unnecessarily obscure subject matters of the present invention.

Hereinafter, an HUD apparatus for realizing multi-display field capable of individual control according to an embodiment of the present invention will be described in detail with reference to the accompanying drawings.

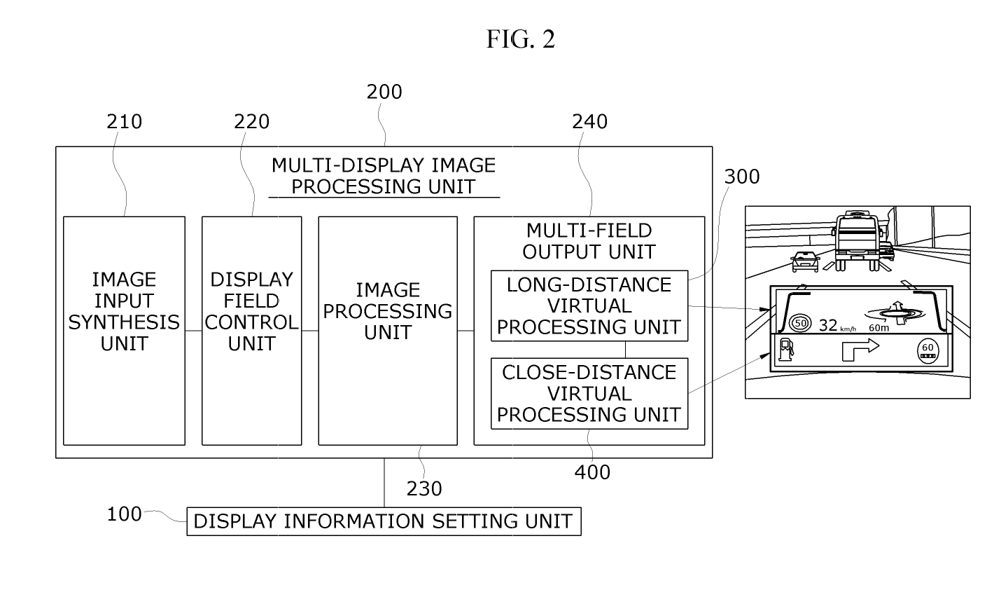

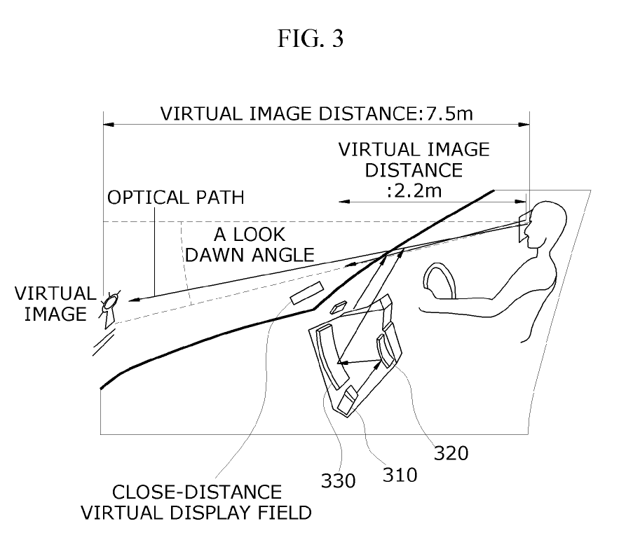

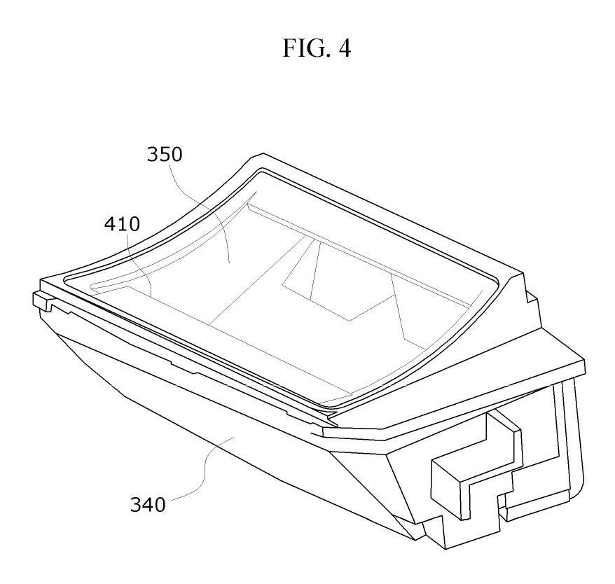

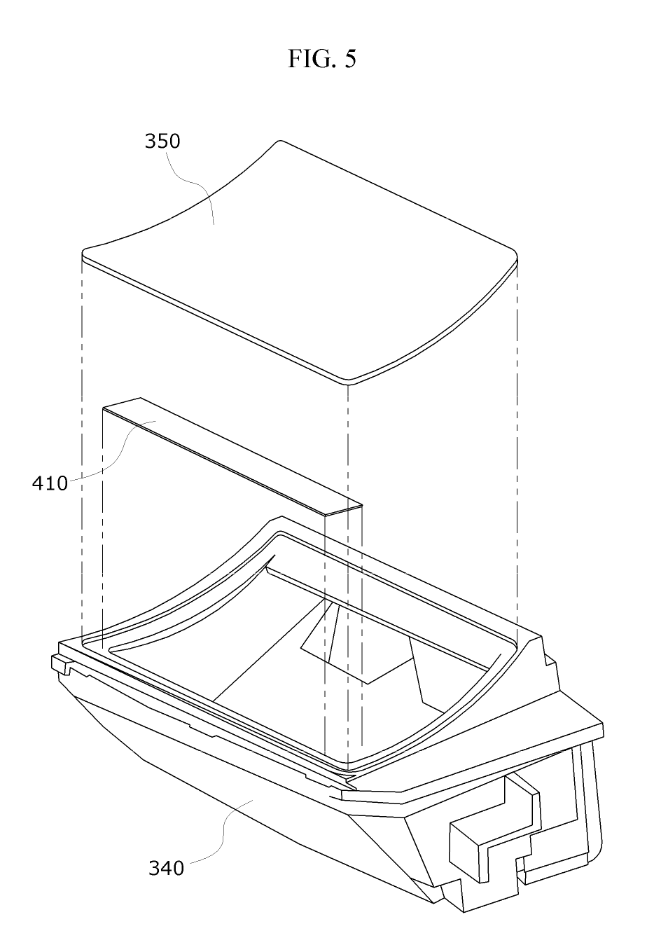

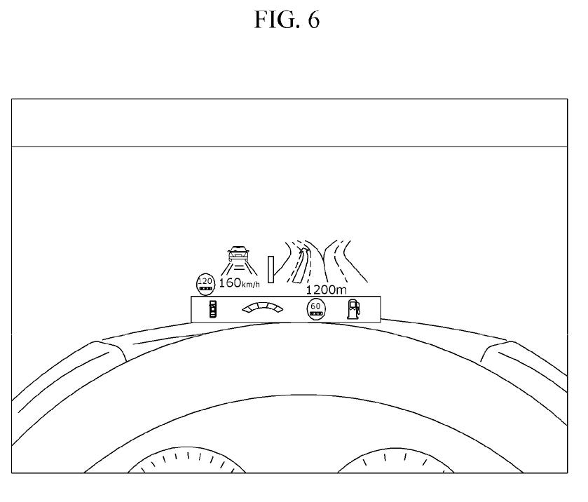

FIG. 2 is a block diagram of an HUD apparatus for realizing multi-display field capable of individual control according to an embodiment of the present invention. FIG. 3 is a diagram schematically illustrating a configuration of a multi-image output unit configuring an HUD apparatus for realizing multi-display field capable of individual control according to an embodiment of the present invention. FIG. 4 is a diagram illustrating an example of a hardware configuration of a multi-image output unit configuring an HUD apparatus for realizing multi-display field capable of individual control according to an embodiment of the present invention. FIG. 5 is an exploded diagram of an example of a hardware configuration of a multi-image output unit configuring an HUD apparatus for realizing multi-display field capable of individual control according to an embodiment of the present invention. FIG. 6 is a diagram showing display information generated by an HUD apparatus for realizing multi-display field capable of individual control according to an embodiment of the present invention.

The HUD apparatus for realizing multi-display field capable of individual control according to an embodiment of the present invention may change one display image (for example, a long-distance display image) and a focal distance by using a long-distance display image output unit and a close-distance display image output unit to generate a field which displays information by using the close-distance display image output unit, and thus, may output display field content by positions.

The HUD apparatus for realizing multi-display field capable of individual control according to an embodiment of the present invention, as illustrated in FIGS. 2 to 6, may include a display information setting unit 100 which selects content which is to be displayed and selects single display or multi-display and a multi-display image processing unit 200 which displays the content set by the display information setting unit 100 on two or more individual display fields.

The display information setting unit 100 may include a content setting which selects one or more pieces of content which is to be displayed by the below-described multi-display image processing unit 200 and a display mode setting which selects whether to display, as a single display field, a display field which is to be displayed by the multi-display image processing unit 200 or whether to display the display field as two or more display fields (in the present invention, two display fields are disclosed).

The display information setting unit 100 may be configured with a software algorithm and a hardware element in association with a central processing unit (CPU) of a vehicle, and its detailed description is omitted. It can be sufficiently understood by those skilled in the art that each of below-described elements is configured with a software algorithm and a hardware element, and thus, for clarity of the present invention and conciseness of description, descriptions of known technical details are omitted.

The multi-display image processing unit 200 may include an image input synthesis unit 210 which selects and synthesizes display information when the display information setting unit 100 sets multi-display, a display field control unit 220 which controls a display field displayed according to the display information synthesized by the image input synthesis unit 210, an image processing unit 230 which corrects distortion of content, which is controlled by the display field control unit 220 and is to be displayed on a virtual field part, and moves a display position, and a multi-field output unit 240 which displays the display information, processed by the image processing unit 230, on two or more fields.

The image input synthesis unit 210 may select and synthesize various pieces of internal and external content of a vehicle such as image information (for example, rear camera image information) from a camera installed in the vehicle and cluster display information displayed on a cluster.

The display field control unit 220 may control pieces of vehicle information which are displayed on a long-distance virtual display field and a close-distance virtual display field which are fields displayed by the multi-image output unit 240.

The image processing unit 230 may process distortion or luminance and brightness of content displayed on a display field. When two or more display fields are displayed, with respect to one display field (for example, the long-distance virtual display field), the image processing unit 230 may control a position of the other display field to perform matching between the display fields.

The multi-image output unit 240 may include a long-distance virtual processing unit 300 including a PGU and a close-distance virtual processing unit 400 including a panel which is provided with an image source and self-emits light to display an image.

The long-distance virtual processing unit 300, as illustrated in FIGS. 3 to 5, may include a PGU 310 which provides the image source, a folding mirror 320 which is an optical system for reflecting an image generated by the PGU 310 and reflects the image generated by the PGU 310, an aspheric mirror 330 which adjusts a projection distance and a magnification of the image reflected by the folding mirror 320 to allow an image to be displayed on a long-distance display field, a module body 340 which accommodates the PGU 310, the folding mirror 320, and the aspheric mirror 330 and includes one surface which is opened to transmit an image from the aspheric mirror 330, and a transparent cover 350 which covers the opened one surface of the module body 340.

Display content provided from the long-distance virtual processing unit 300 may include, for example, a direction, a velocity, and map information which correspond to main vehicle information display.

The close-distance virtual processing unit 400 may include an image source output unit (not shown) which outputs the image source and a self-emitting panel 410 which is provided with an image output from the image source output unit (not shown) and self-emits light to display the image.

Here, as illustrated in FIGS. 4 and 5, for example, the self-emitting panel 410 of the close-distance virtual processing unit 400 may be configured with an organic light emitting diode (OLED) panel which is deposited on one side (a lower end) of the transparent cover 350 of the long-distance virtual processing unit 300.

A virtual display field displayed by the close-distance virtual processing unit 400 may be displayed in matching with the transparent cover 350, and thus, may be fundamentally displayed in matching with a virtual display field displayed by long-distance virtual processing unit 300.

Information displayed by the close-distance virtual processing unit 400 may be auxiliary information when a vehicle is driving at a high speed and may be configured to display a warning light, a time, refueling, an external camera image (a rear camera image in backing), etc., and moreover, may be configured to display only desired significant information when long-distance projection is not desired due to low-speed driving or a front vehicle.

As described above, multi-display based on the long-distance virtual processing unit 300 and the close-distance virtual processing unit 400 of the multi-image processing unit 200 may be displayed as in FIG. 6, and by divisionally providing a multi-display field, information is provided to a driver in an optimal environment.

Moreover, the display field control unit 220 of the multi-image processing unit 200 may be configured in association with a velocity of a vehicle. Also, the display field control unit 220 may change information displayed by the multi-image output unit 240, based on a velocity and may be automatically set so as to display other content on the changed field.

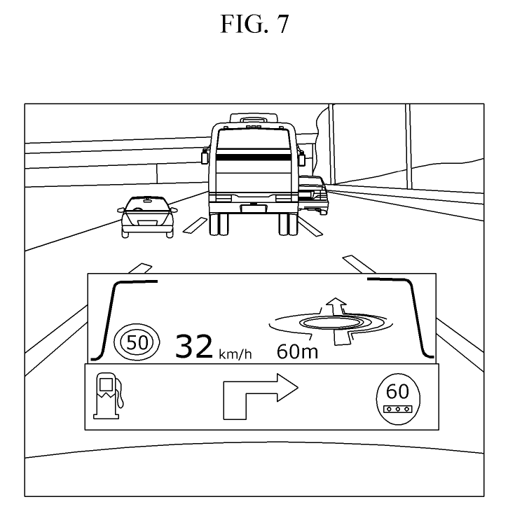

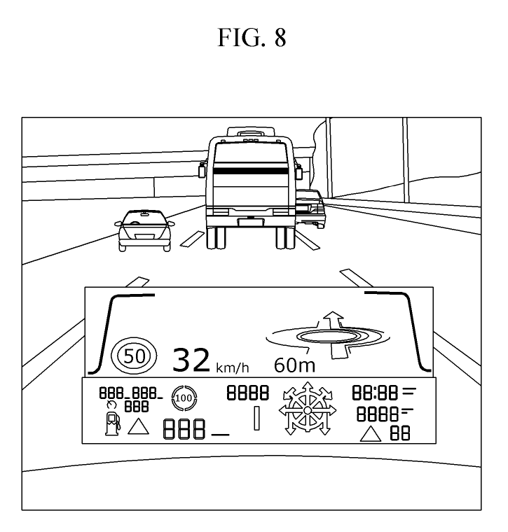

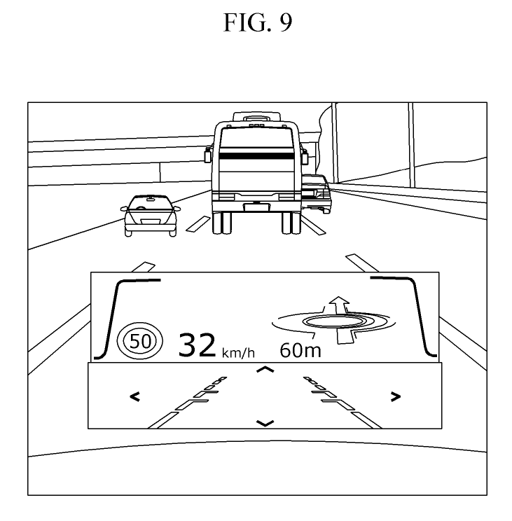

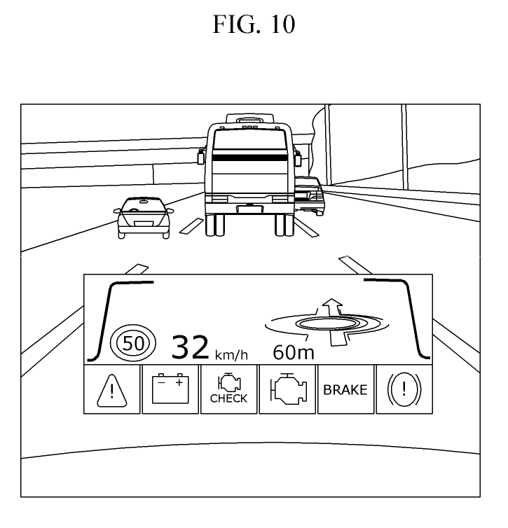

For example, as illustrated in FIGS. 7 to 10, the display field control unit 220 may perform control to allow the long-distance virtual display unit 300 to display vehicle significant information, a previous HUD image, and an augmented reality (AR) image and to allow the close-distance virtual display unit 400 to display an icon corresponding to rear camera image information as well as the previous HUD image, a vehicle warning light displayed on the cluster, or a seat belt sign, or may perform various controls to display a combination thereof. FIGS. 7 to 10 are diagrams showing an example of various pieces of content displayed by the multi-image output unit in the HUD apparatus for realizing multi-display field capable of individual control according to an embodiment of the present invention.

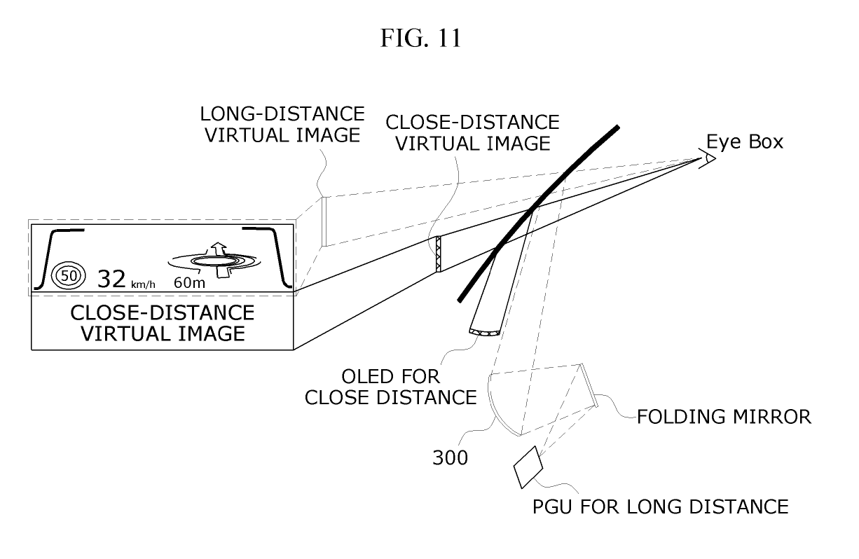

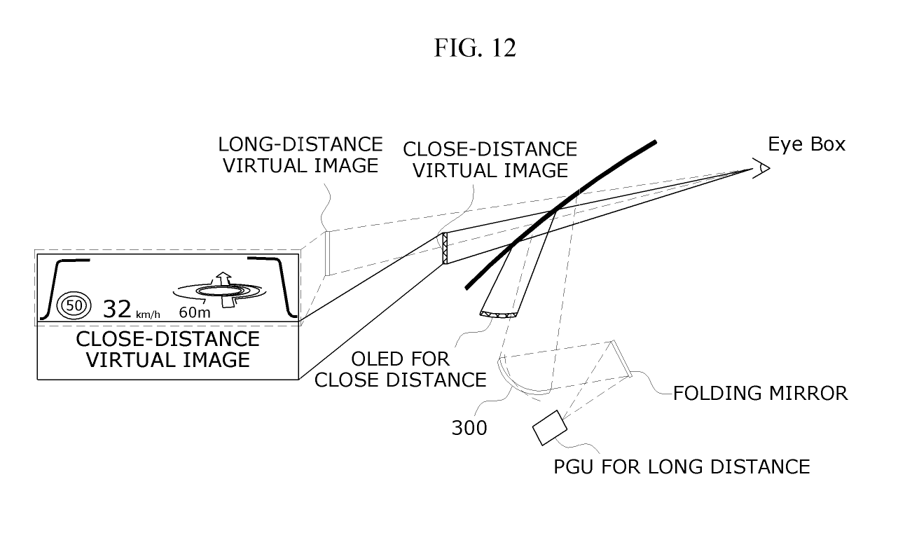

An operation of performing overlap correction in an operation performed by the HUD apparatus for realizing multi-display field capable of individual control according to an embodiment of the present invention will be described below with reference to FIGS. 11 and 12.

FIG. 11 is a diagram illustrating an example where multi display fields are aligned and displayed in the HUD apparatus for realizing multi-display field capable of individual control according to an embodiment of the present invention. FIG. 12 is a diagram illustrating an example of controlling an aspheric mirror when multi display fields are displayed to overlap one another, in the HUD apparatus for realizing multi-display field capable of individual control according to an embodiment of the present invention.

In the HUD apparatus for realizing multi-display field capable of individual control according to an embodiment of the present invention, in a case where a display field is displayed in plurality and executed in the multi-display image processing unit 200, as illustrated in FIG. 11, a long-distance virtual image corresponding to a long-distance display field generated by the long-distance virtual processing unit 300 and a close-distance virtual image corresponding to a close-distance display field generated by the close-distance virtual processing unit 400 may be respectively displayed on an upper end and a lower end in a virtual image field which a driver actually watches, and may be displayed not to overlap each other, based on a light path.

However, as illustrated in FIG. 12, when the long-distance virtual image corresponding to the long-distance display field overlaps the close-distance virtual image corresponding to the close-distance display field, the close-distance virtual image generated by the close-distance virtual processing unit 400 may be displayed at a fixed position, and thus, may be aligned by controlling the aspheric mirror 330 of the long-distance virtual processing unit 300.

Moreover, whole brightness or luminance may be adjusted by the image processing unit 230, and additionally, the close-distance virtual processing unit 400 configured with the self-emitting panel may perform on/off control. Also, the long-distance virtual processing unit 300 may perform control through brightness control by the PGU 310.

Therefore, depending on the case, the display field control unit 220 and the image processing unit 230 may be omitted, or may be integrated with a configuration of the multi-image output unit 240. For example, the image processing unit 230 may be configured with the aspheric mirror of the long-distance virtual processing unit 300.

To briefly describe a display control method of the HUD apparatus for realizing multi-display field capable of individual control according to an embodiment of the present invention, driving information and/or desired vehicle information generated from a main image source may be displayed on a virtual main display field, and driving information or image information and/or desired vehicle information generated from the main image source and one or more sub image sources may be displayed on a virtual sub display field.

When it is desired that a virtual image displayed on the main display field and a virtual image displayed on the sub display field overlap each other or move, by controlling an optical system configuring a device which generates the main image source and the sub image source, a display position at which an image is displayed may be adjusted, or a size of a virtual image displayed on a display field may be adjusted.

A device for generating the main image source may be configured with a PGU, and a device for generating the sub image source may be configured with a self-emitting panel which is provided in a transparent cover configuring the PGU.

In the HUD apparatus for realizing multi-display field capable of individual control and the display control method thereof according to the embodiments of the present invention, close-distance virtual information and long-distance virtual information (image information) may be displayed through a plurality of individual displays, and a plurality of display fields may be generated to minimize a movement of an eye-gaze of a driver, namely, provides various pieces of vehicle information along with minimizing dispersion of the eye-gaze while the driver is driving a vehicle, thereby enhancing driving safety and convenience.

Moreover, according to the embodiments of the present invention, since various pieces of information about a warning light obtained from a conventional cluster are displayed, the cluster is omitted, and thus, the number of elements is reduced and lightness is realized. Also, since a space occupied by the cluster is used as another space, the usability of a space increases. Also, a total size increases in a case of configuring a conventional AR-HUD apparatus having a large screen, but according to the embodiments of the present invention, a large screen is displayed even without any change in uniform resolution.

The HUD apparatus for realizing multi-display field capable of individual control and the display control method thereof according to the embodiments of the present invention provide the following effects.

First, close-distance virtual information and long-distance virtual information (image information) may be displayed through a plurality of individual displays, and a plurality of display fields may be generated to minimize a movement of an eye-gaze of a driver, namely, provides various pieces of vehicle information along with minimizing dispersion of the eye-gaze while the driver is driving a vehicle, thereby enhancing driving safety and convenience.

Second, since various pieces of information about a warning light obtained from a conventional cluster are displayed, the cluster is omitted, and thus, the number of elements is reduced and lightness is realized. Also, since a space occupied by the cluster is used as another space, the usability of a space increases.

Third, a total size increases in a case of configuring a conventional AR-HUD apparatus having a large screen, but according to the embodiments of the present invention, a large screen is displayed even without any change in uniform resolution.

In exemplary embodiments, multi-display image processing unit 200, display information setting unit 100, and/or one or more components thereof, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to one or more exemplary embodiments, the features, functions, processes, etc., described herein may be implemented via software, hardware (e.g., general processor, digital signal processing (DSP) chip, an application specific integrated circuit (ASIC), field programmable gate arrays (FPGAs), etc.), firmware, or a combination thereof. In this manner, multi-display image processing unit 200, display information setting unit 100, and/or one or more components thereof may include or otherwise be associated with one or more memories (not shown) including code (e.g., instructions) configured to cause multi-display image processing unit 200, display information setting unit 100, and/or one or more components thereof to perform one or more of the features, functions, processes, etc., described herein.

The memories may be any medium that participates in providing code to the one or more software, hardware, and/or firmware components for execution. Such memories may be implemented in any suitable form, including, but not limited to, non-volatile media, volatile media, and transmission media. Non-volatile media include, for example, optical or magnetic disks. Volatile media include dynamic memory. Transmission media include coaxial cables, copper wire and fiber optics. Transmission media can also take the form of acoustic, optical, or electromagnetic waves. Common forms of computer-readable media include, for example, a floppy disk, a flexible disk, hard disk, magnetic tape, any other magnetic medium, a compact disk-read only memory (CD-ROM), a rewriteable compact disk (CD-RW), a digital video disk (DVD), a rewriteable DVD (DVD-RW), any other optical medium, punch cards, paper tape, optical mark sheets, any other physical medium with patterns of holes or other optically recognizable indicia, a random-access memory (RAM), a programmable read only memory (PROM), and erasable programmable read only memory (EPROM), a FLASH-EPROM, any other memory chip or cartridge, a carrier wave, or any other medium from which information may be read by, for example, a controller/processor.

Although exemplary embodiments of the present disclosure have been shown and described hereinabove, the present disclosure is not limited to specific exemplary embodiments described above, but may be various modified by those skilled in the art to which the present disclosure pertains without departing from the scope and spirit of the disclosure as disclosed in the accompanying claims. In addition, such modifications should also be understood to fall within the scope and spirit of the present disclosure.

What is claimed is:

1. A head up display (HUD) apparatus for realizing multi-display field, the HUD apparatus comprising:
a first image processing unit allowing a virtual image, corresponding to driving information or vehicle information generated from a first image source, to be displayed on a main display field; and
a second image processing unit allowing a virtual image, corresponding to at least one of driving information, image information, and vehicle information generated from a second image source, to be displayed on a sub display field.

2. The HUD apparatus of claim 1, wherein
the first image processing unit allows a first virtual image to be displayed at a distance relatively far away from a driver,
the second image processing unit allows a second virtual image to be displayed at a distance relatively close to the driver, and
the first virtual image and the second virtual image are vertically or laterally aligned and displayed.

3. The HUD apparatus of claim 2, wherein
the first image processing unit comprises:
a picture generation unit providing an image source;
an optical system reflecting an image generated by the picture generation unit to allow the first virtual image to be displayed on a display field disposed at a certain distance;
a module body including one surface opened to transmit the first virtual image, the optical system being accommodating into the module body; and
a transparent cover covering the opened one surface of the module body, and
the second image processing unit comprises:
an image source output unit outputting the image source; and
a self-emitting panel provided with an image output from the image source output unit to display a corresponding image as a second virtual image on a display field disposed at a certain distance by self-emitting light.

4. The HUD apparatus of claim 3, wherein
the first virtual image is an image corresponding to content including vehicle driving information, and
the second virtual image is an image corresponding to content including image information provided from a camera equipped in the vehicle and cluster display information.

5. The HUD apparatus of claim 4, wherein at least one of the first virtual image and the second virtual image is configured for image correction to be performed.

6. The HUD apparatus of claim 5, wherein
the first virtual image is corrected by controlling an aspheric mirror configuring the optical system of the first image processing unit, and
the second virtual image is a fixed image.

7. A head up display (HUD) apparatus for realizing multi-display field, the HUD apparatus comprising:
a display information setting unit selecting content which is to be displayed, and selecting single display or multi-display; and
a multi-display image processing unit displaying the content set by the display information setting unit on two or more individual display fields.

8. The HUD apparatus of claim 7, wherein the multi-display image processing unit comprises:
an image input synthesis unit selecting and synthesizing display information when the display information setting unit sets multi-display; and
a multi-field output unit displaying display information, obtained through processing by the image input synthesis unit, on two or more fields.

9. The HUD apparatus of claim 8, wherein the image input synthesis unit is provided with content including cluster display information and image information obtained from a camera installed in a vehicle and selects and synthesizes the content.

10. The HUD apparatus of claim 9, wherein the multi-image output unit comprises:
a long-distance virtual processing unit including a picture generation unit; and
a close-distance virtual processing unit including a panel provided with an image source to display an image by self-emitting light.

11. The HUD apparatus of claim 10, wherein the long-distance virtual processing unit comprises:
an image generation unit providing the image source;
an optical system reflecting an image generated by the image generation unit to allow a virtual image to be displayed on a display field disposed at a certain distance;
a module body including one surface opened to transmit the virtual image, the optical system being accommodating into the module body; and
a transparent cover covering the opened one surface of the module body.

12. The HUD apparatus of claim 11, wherein the close-distance virtual processing unit comprises:
an image source output unit outputting the image source; and
a self-emitting panel provided with an image output from the image source output unit to display a corresponding image as a virtual image on a display field disposed at a certain distance by self-emitting light.

13. The HUD apparatus of claim 12, wherein
the long-distance virtual processing unit comprises:
an image generation unit providing the image source;
an optical system reflecting an image generated by the image generation unit to allow a virtual image to be displayed on a display field disposed at a certain distance;
a module body including one surface opened to transmit the virtual image, the optical system being accommodating into the module body; and
a transparent cover covering the opened one surface of the module body, and
the close-distance virtual processing unit comprises:
an image source output unit outputting the image source; and
a self-emitting panel provided with an image output from the image source output unit to display a corresponding image as a virtual image on a display field disposed at a certain distance by self-emitting light.

14. The HUD apparatus of claim 13, wherein the self-emitting panel of the close-distance virtual processing unit comprises an organic light emitting diode (OLED) panel deposited on one side of the transparent cover of the long-distance virtual processing unit.

15. The HUD apparatus of claim 14, further comprising:
a display field control unit controlling information about each of a long-distance virtual display field and a close-distance virtual display field which are fields displayed by the multi-image output unit; and
an image processing unit correcting distortion of content which is controlled by the display field control unit and is to be displayed on a display field, and moving a display position.

16. A display control method of a head up display (HUD) apparatus for realizing multi-display field, the display control method comprising:
allowing cluster information or driving information generated from a main image source to be displayed on a virtual main display field; and
allowing at least one of driving information, image information, and cluster information generated from a second image source and one or more sub image sources to be displayed on a virtual sub display field.

17. The display control method of claim 16, further comprising: adjusting luminance, brightness, and a position of each of a virtual image displayed on the virtual main display field and a virtual image displayed on the virtual sub display field.
